(19) United States
(12) Patent Application Publication
(10) Pub. No.: US 2006/0097660 A1
(43) Pub. Date: May 11, 2006

(54) Apparatus, system, and method for controlling remote lighting devices

(76) Inventors: Deborah Scott, Pleasant Hill, CA (US); Will L. Gordon, Santa Maria, CA (US); Michael W. Starkweather, Sandy, UT (US)

Correspondence Address: Starkweather and Associates, Suite 200, 9035 South 1300 East, Sandy, UT, 84094, US

(21) Appl. No.: 10/985,399

(22) Filed: Nov. 9, 2004

(51) Int. Cl. H05B 41/36

(52) U.S. Cl. 315/291

(57) ABSTRACT

An apparatus, system, and method for controlling remote lighting devices via radio frequency. The lighting device includes a housing, a power source, a light source, a signal receiver and a signal processor. The light source emits light in response to an appropriate signal received. The apparatus is configured to be held by human users, or attached to their person via a securing means. A system for controlling the lights includes at least one transmitter for transmitting the signal, a processor communicably coupled to the transmitter for providing instructions to the transmitter when to transmit the signal, and a plurality of lighting devices. A method includes the steps of providing at least one transmitter to transmit the signal, providing a processor to provide instructions to the transmitter when to transmit the signal, and providing a plurality of lighting devices.

### BACKGROUND OF THE INVENTION

1. Field of the Invention

This invention relates to light systems and more particularly relates to controlling remote lighting devices via radio frequency.

2. Description of the Related Art

Lighting devices have been used for many years to provide light at all times of day and in all locations. Likewise, lighting devices have been used for entertainment purposes, such as Christmas lights, stage lights, and laser light shows. Laser light shows, in particular, have been used at concerts, sporting events, special occasions, and at theaters. Since their introduction, laser light shows have been extremely popular and have attracted millions of spectators.

One disadvantage of typical light shows for entertainment purposes is that there is very little, if any, spectator participation. Due to safety reasons, lasers cannot be handled by untrained professionals, and lasers should not be directed towards humans. Generally, laser light shows involve spectators viewing the lasers directed towards a wall or a ceiling. Accordingly, a second disadvantage is that typical light shows require some kind of wall or ceiling to display the lights. As a result, it is difficult to perform light shows at outdoor events without significant preparation and cost.

From the foregoing discussion, it should be apparent that a need exists for an apparatus, system, and method that provides for light shows in all locations, without significant preparation, and which provides for significant spectator participation.

### SUMMARY OF THE INVENTION

The present invention has been developed in response to the present state of the art, and in particular, in response to the problems and needs in the art that have not yet been fully solved by currently available light controlling apparatus, systems, and methods. Accordingly, the present invention has been developed to provide an apparatus, system, and method for controlling remote lighting devices that overcome many or all of the above-discussed shortcomings in the art.

The apparatus, in one embodiment, is configured to emit light in response to reception of a signal from a transmitter. The signal may be transmitted via radio frequency or other transmitting means, such as infrared. The apparatus is configured to be held by human users, or attached to their person via a securing means. A light source emits the light and comprises at least one light-emitting diode. In another embodiment, the apparatus is configured to emit a plurality of colors from different light emitting diodes.

The apparatus, in yet another embodiment, is configured to receive processing command codes via the radio frequency and illuminate the light-emitting diodes individually or jointly, to produce a desired color of light. The lighting device may be programmed with a unique address to receive individual instructions.

A system of the present invention is also presented to control lighting devices using a signal. The system, in one embodiment, includes at least one transmitter configured to transmit the signal, a processor communicably coupled to the transmitter, configured to provide instructions to the transmitter when to transmit the signal, and a plurality of lighting devices, with each lighting device comprising a receiver, a signal processor, and a light source electrically coupled to the signal processor. In one embodiment, the signal is transmitted via radio frequency.

The system, in another embodiment, includes a plurality of transmitters located at predetermined locations remote from the processor. The transmitters transmit radio frequency to lighting devices located within a zone about the transmitters. In effect, only the lighting devices within the zones emit light in response to the radio frequency. A single transmitter, in another embodiment, may be located on a stage and configured to transmit the signal to lighting devices being used by an audience watching a concert being performed on the stage.

The transmitters, in yet another embodiment, are directional and configured to direct the radio frequency to a specific location.

The processor, in still another embodiment, may be programmable to instruct specific transmitters to transmit the radio frequency, while other transmitters are not instructed to transmit anything.

A method of the present invention is also presented for controlling lighting devices using a signal. The method in the disclosed embodiments substantially includes the steps necessary to carry out the functions presented above with respect to the operation of the described apparatus and system. In one embodiment, the method includes the steps of providing at least one transmitter configured to transmit the signal, providing a processor communicably coupled to the transmitter, configured to provide instructions to the transmitter when to transmit the signal, and providing a plurality of lighting devices, each lighting device comprising a receiver, configured to receive the signal, a signal processor configured to process the signal, and a light source coupled to the receiver and configured to emit a light when the receiver receives the signal.

The method, in another embodiment, includes the step of positioning a plurality of transmitters at predetermined locations remote from the processor, and transmitting the radio frequency to the lighting devices located within a zone about the transmitters, such that only the lighting devices within the zones emit light in response to the radio frequency.

The method, in yet another embodiment, further includes the step of receiving processing command codes over the radio frequency link between the lighting device and the processor, to illuminate a plurality of light-emitting diodes individually or jointly, to produce a desired color of light. Each signal processor may be programmed with a unique address such that the processor is able to provide individual instructions to each lighting device.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a lighting device according to one embodiment of the present invention;

FIG. 2 illustrates a lighting device and transmitter for controlling the lighting device according to one embodiment of the present invention;

FIG. 3 illustrates a system for transmitting a signal to unique lighting devices according to one embodiment of the present invention;

FIG. 4 illustrates a flow chart for controlling lighting devices through a single transmitter according to one embodiment of the present invention;

FIG. 5 illustrates a system for transmitting a signal to various lighting devices according to one embodiment of the present invention;

FIG. 6 illustrates a system for transmitting a signal to various lighting devices at a concert in accordance to one embodiment of the present invention;

FIG. 7 illustrates a system for transmitting a signal to various transmitters to control lighting devices in zones according to one embodiment of the present invention; and

FIG. 8 is a schematic flow chart diagram illustrating a method for controlling lighting devices in zones in accordance with one embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Additionally, the following schematic flow chart diagrams are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbology employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

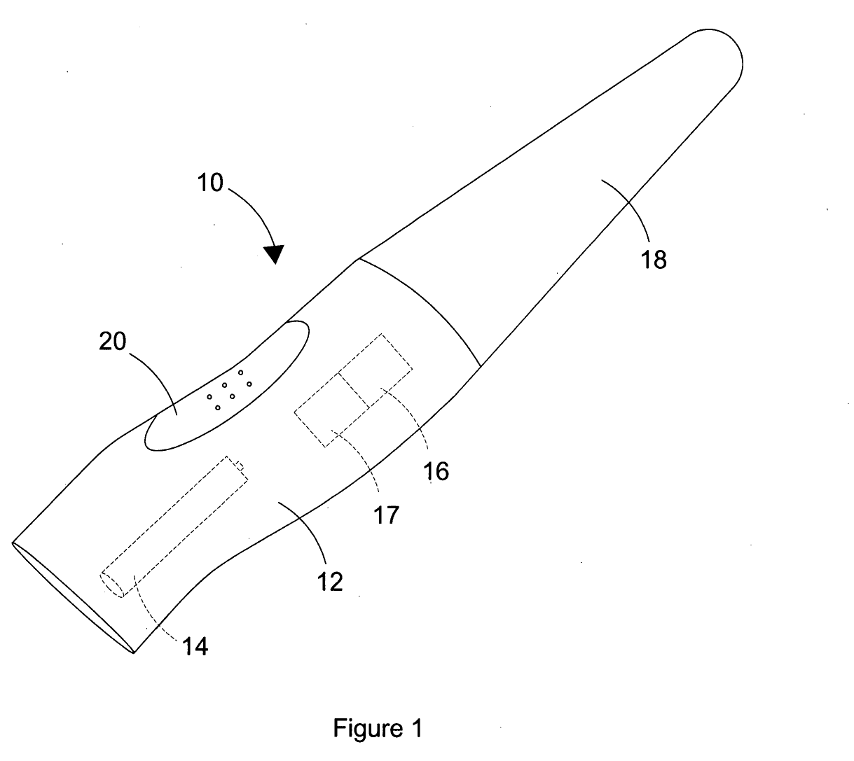

FIG. 1 depicts a lighting device 10 for emitting a light in response to a command through a signal, such as a radio frequency (“RF”), according to one embodiment of the present invention. The lighting device comprises a housing 12, a power source 14, a receiver 16, a signal processor 17, and a light source 18 electrically coupled to the power source 14. In the illustrated embodiment, the lighting device 10 features an on/off switch 20.

The light source 18 extends from the housing 12 to increase visibility of the light. In one embodiment, the light source 18 comprises a plurality of light emitting diodes (“LED's”). The LED's may be any color. In one embodiment, the light source 18 comprises four strategically placed tri-colored LED's.

The receiver 16 is configured to receive the RF and the processor 17 is configured to process the RF. Preferably, the lighting devices 10 are wireless and receive the RF from remote transmitters (not shown).

The lighting device 10 of the illustrated embodiment is configured to be hand held by human users. It is also envisioned that the lighting device 10 may be attached to the user's person via a securing means. The lighting device 10 may resemble a bracelet, an anklet, a necklace, or a broach, and may attach to the person's clothing via a clamp, clasp, pin, tape, glue, stitch, or any other known method.

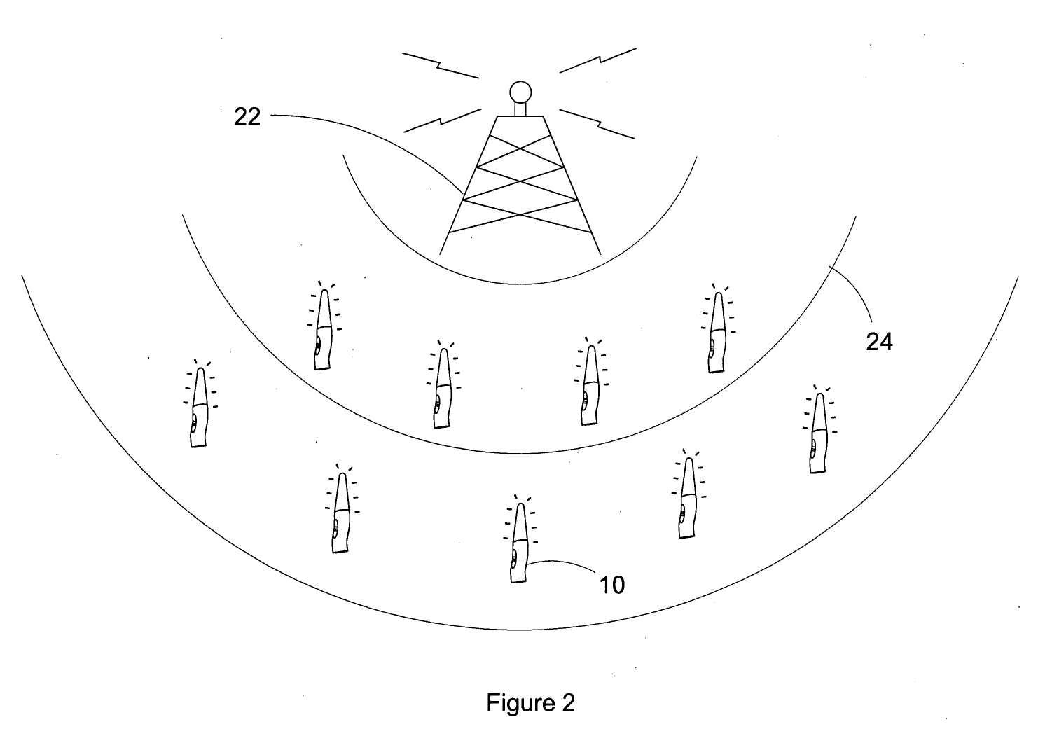

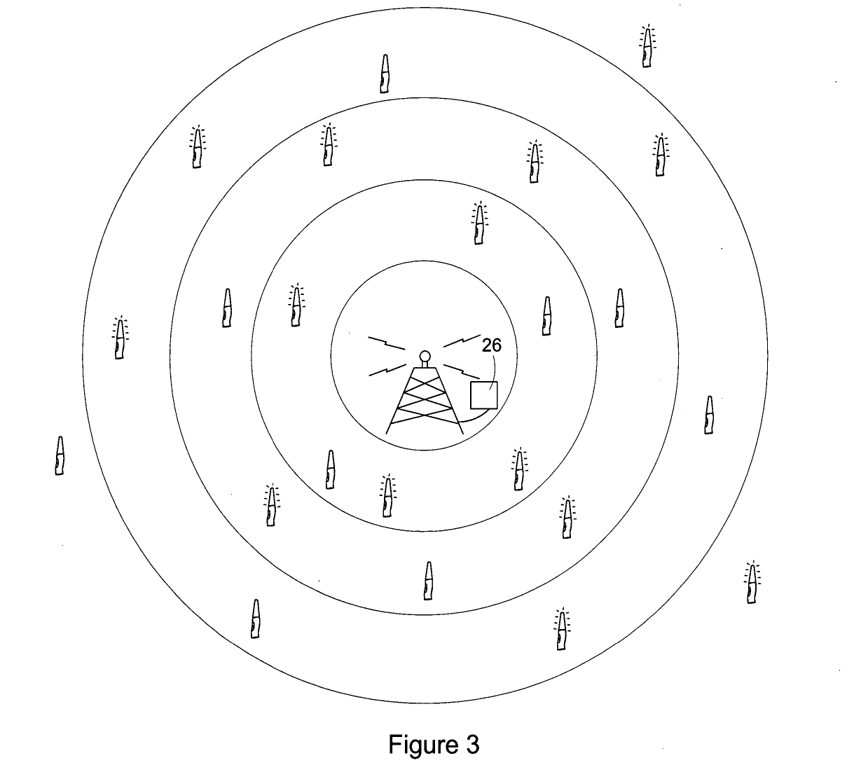

FIGS. 2 and 3 illustrate the lighting device 10 and transmitter 22 for controlling the lighting device according to one embodiment of the present invention. The transmitter 22 is positioned to encode and transmit the signal 24 to the lighting devices 10. The receivers 16 (See FIG. 1) receive the signal 24 and the signal processors 17 (See FIG. 1) process the commands embedded within the signal 24 to cause the light source 18 (See FIG. 1) to emit light. The signal 24 may be transmitted in any direction.

In another embodiment, the signal processor 17 receives processing command codes from the transmitters via the radio frequency and illuminates the LED's individually or jointly, to produce a desired color of light. The processor 17 may be preprogrammed with a unique address and configured to receive individual instructions from the transmitter 22. If the RF does not include command code for a particular address, the command is ignored. Advantageously, a multiplicity of lighting devices being used by a large crowd can be individually controlled and each individual lighting device can receive instructions to perform specific light exhibits. For example, one lighting device may receive a signal instructing the LED's to blink, while another lighting device may receive a signal instructing the LED's to hold an illumination for a fixed period of time. Naturally, any combination of light exhibits may be accomplished.

The signal processor 17 may also be programmed with a second, third, or more, addresses reserved for global commands to control entire groups of lighting devices 10. As a result, all the lighting devices 10 may receive commands to emit light; particular groups of lighting devices 10 may receive commands to blink, etc.

The signal 24 may include other command codes that instruct the lighting device 10 to light specific LED's, or combinations of specific colored LED's.

In another embodiment, the transmitter 22 may be positioned above the lighting devices 10. In particular, in a stadium, or other structure, the transmitter(s) 22 may be positioned in rafters, hung from wires, or connected to a ceiling, and configured to direct the signal 24 towards the lighting devices 10 below, or towards a crowd of people holding the lighting devices 10.

In one embodiment, the transmitter(s) 22 may be movable and directional such that the transmitter(s) can be aimed, pointed, or directed towards a single lighting device 10, or towards a single person, or group. In this manner, users manning the transmitters 22, manually or electronically, can cause the lighting devices 10 to emit light to form unique patterns of light. The transmitters 22 may be rotated or manipulated in such a way as to direct the signal 24 in a pattern over the crowd. With the lighting devices 10 programmed to emit the light for, say one second, the transmitter 22 can complete a full sequence of the pattern within that time frame, thus resulting in a visible pattern of light, in the shape of a diamond, a square, a triangle, or a circle, for example. Multiple transmitters 22 may be used to create complex patterns.

In yet another embodiment, a specific image may be created with the lighting devices 10. A scanner scans the crowd to determine the unique address of each lighting device 10. A central processor 26 encodes the RF with specific instructions for each unique address assigned to each lighting device 10. The transmitters transmit the RF to the lighting devices 10, which receive and process the signal and emit light based on the specific instructions received. For example, the specific image to be displayed may be a photograph of a famous singer. Each lighting device 10, emits a color intended to represent a color feature of the famous singer. If the singer has blue eyes, at least one of the lighting devices 10 emits a blue light. Naturally, some of the lighting devices 10 will emit red light to represent the lips. The color of the skin, hair, clothing, etc, will be represented by colors emitted from other lighting devices 10. The lighting devices 10 may be programmed to emit the representative colors for any period of time, however, it is recognized that as the lighting devices 10 move, the image may become distorted. In one embodiment, a camera may be used to display the image created by the lighting devices 10 on a screen to be seen by everyone in the crowd.

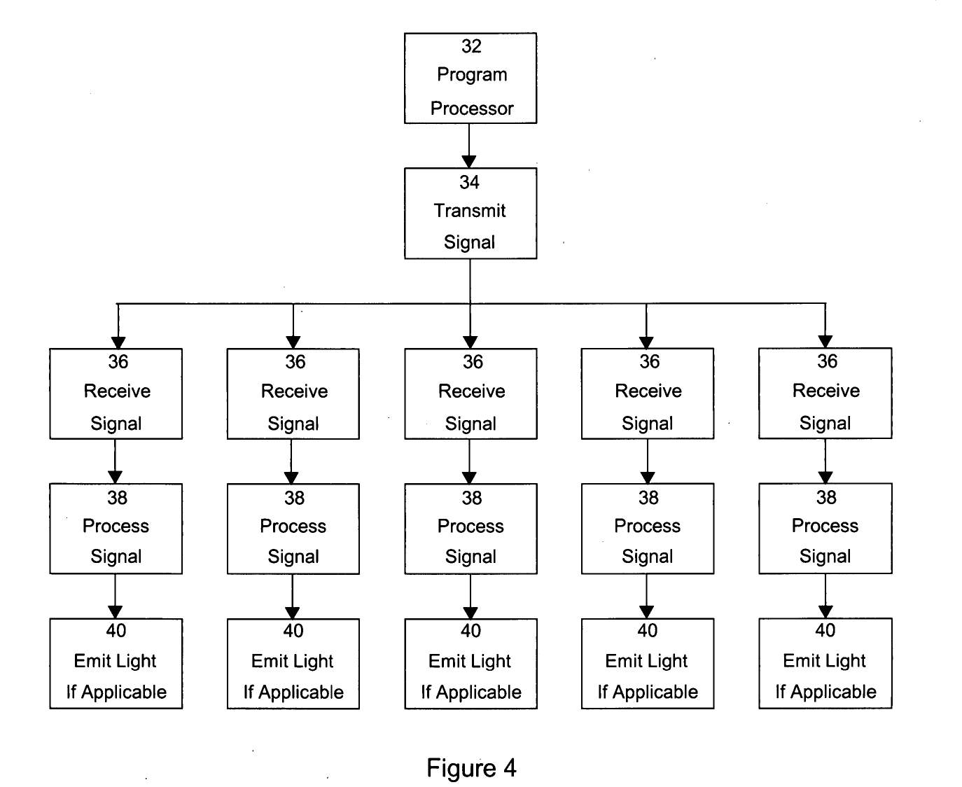

FIG. 4 is a flow chart illustrating a process for controlling lighting devices 10 (See FIG. 1) according to one embodiment of the present invention. The processor 26 (See FIG. 3) is programmed 32 with specific instructions for controlling lighting devices 10. The processor 26 instructs the transmitter 22 (See FIG. 3) to transmit 34 the signal 24 (See FIG. 3) to various lighting devices 10. As discussed above, the signal 24 may be encoded for receipt 36 and execution by specific lighting devices 10 programmed with unique or global addresses. The lighting devices 20 process 38 the signal 24 and, if applicable, emit the light 40 in accordance with the encoded signal 24.

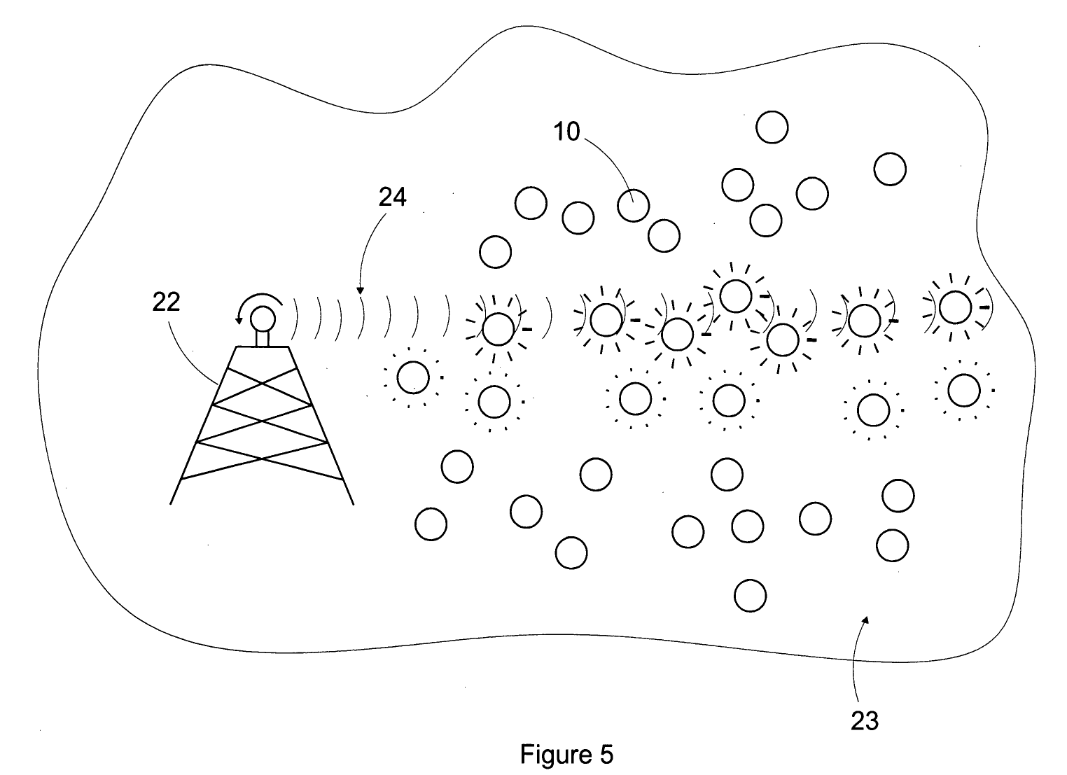

In another embodiment, illustrated in FIG. 5, the transmitter 22 may be configured with a motor to rotate the transmitter 22 about a central location to direct the signal 24 across a crowd 23. As the transmitter 22 rotates, the transmitter 22 directs the signal 24 as a beam. As a result, lighting devices 10 in the path of the signal 24 emit light, producing a “wave” effect.

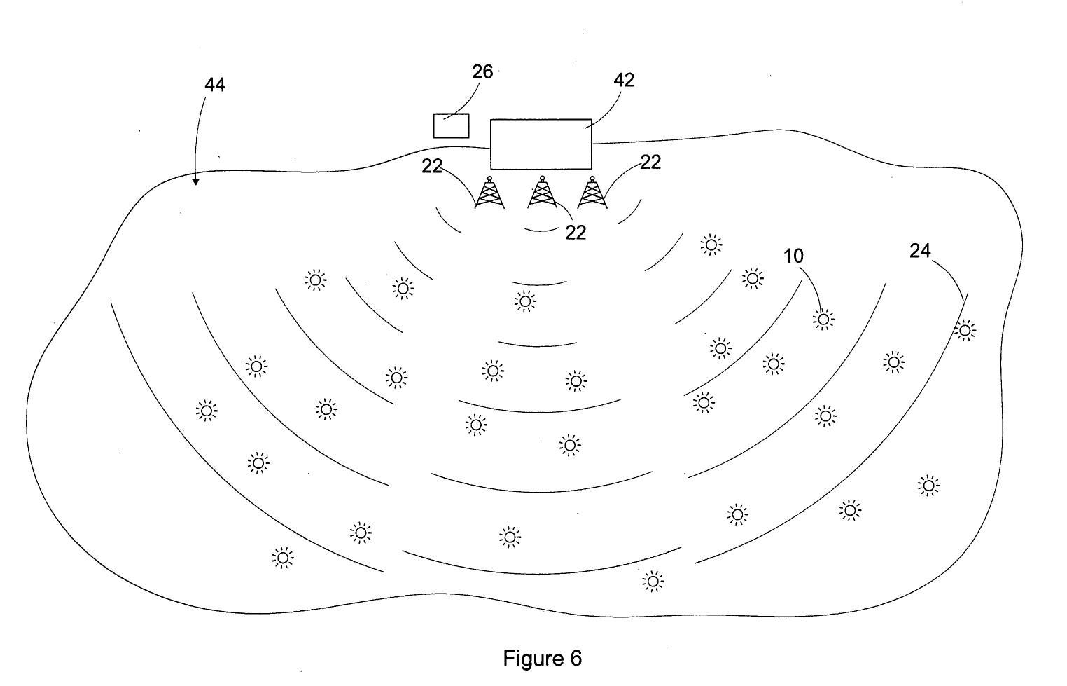

In still another embodiment, illustrated in FIG. 6, the transmitters 22 are located on a stage 42 and configured to transmit the signal 24 to lighting devices 10 being used by an audience 44 watching a concert being performed on the stage 42. As discussed above, the transmitters 22 may be used to transmit RF to the lighting devices 10, individually, as groups, or as a whole throughout the concert. The central processor 26 (see FIG. 3) may be programmed to create rhythms of light, such as flashing groups, individually flashing lighting devices 10, pulses of lights, or rolling lights that mimic the motions of an electronic display of a graphic equalizer, which radiate from a fixed position, such as the stage 42. In another embodiment, the central processor 26 may be programmed to instruct the transmitters 22 to transmit RF with command code that lights the lighting devices 10 according to the beat of the music being played on the stage. One skilled in the art will recognize that there are innumerable ways that the lighting devices 10 can be controlled.

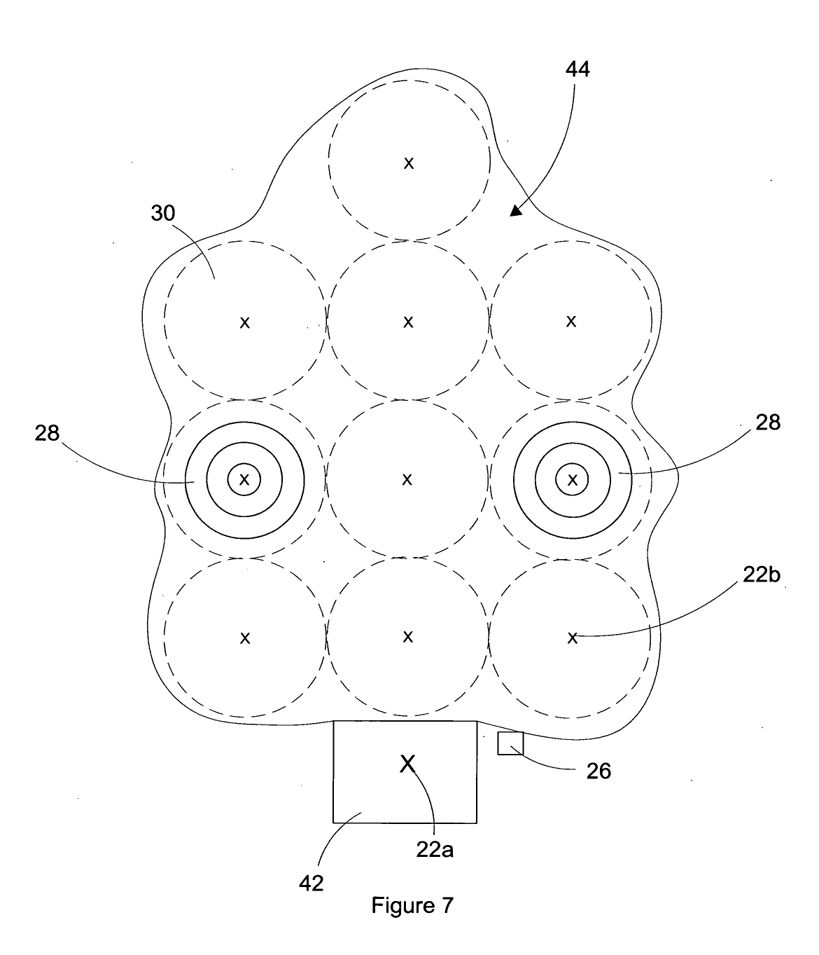

FIGS. 7 and 8 illustrate a system and flow chart for controlling lighting devices 10 via a plurality of transmitters 22 according to one embodiment of the present invention. The illustrated embodiment depicts a central transmitter 22a transmitting signals to various remote transmitters 22b. A central processor 26 instructs 46 the central transmitter 22a which remote transmitters 22b are to transmit signals, and which commands are to be transmitted, to the lighting devices 10. The central transmitter 22a transmits 48 the information to the remote transmitters 22b. The remote transmitters 22b receive and process 50 the signal 24 and transmit the instructions to the lighting devices for receipt 52 and processing 54. In this manner, groups of lighting devices 10 within an active zone 28 around the remote transmitter 22a can be instructed to emit light 56, if applicable. As a result, a lighting device 10 being held in the active zone 28 receives commands from the remote transmitter 22a, while lighting devices in inactive zones 30 do not receive the command, or the lighting devices 10 in inactive zones 30 receive different commands.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for emitting a light in response to a signal comprising:
a housing;
a power source;
a receiver, configured to receive the signal from a transmitter;
a signal processor, configured to process the signal; and
a light source electrically coupled to the signal processor and the power source, and configured to emit a light when the signal processor processes the signal.

2. The apparatus according to claim 1, wherein the signal is transmitted via radio frequency.

3. The apparatus according to claim 1, wherein the housing is configured to be held by human users, or attached to their person.

4. The apparatus according to claim 1, wherein the housing is configured to be a handheld wand, bracelet, or anklet, or attached to a user via a securing means.

5. The apparatus according to claim 1, wherein the light source comprises at least one light-emitting diode.

6. The apparatus according to claim 4, comprising a plurality of light-emitting diodes, and wherein the light emitting diodes are different colors.

7. The apparatus according to claim 6, wherein the signal processor receives processing command codes via the radio frequency and illuminates the light-emitting diodes individually, or jointly, to produce a desired color of light.

8. The apparatus according to claim 7, wherein the lighting device is programmed with a unique address and configured to receive individual instructions.

9. A system for controlling lighting devices using a wireless signal comprising:
at least one transmitter configured to transmit the signal;
a processor communicably coupled to the transmitter, configured to provide instructions to the transmitter when to transmit the signal; and
a plurality of lighting devices, each lighting device comprising:
a receiver, configured to receive the signal; and
a light source electrically coupled to the receiver and configured to emit a light when the receiver receives the signal.

10. The system according to claim 9, wherein the signal is transmitted via radio frequency.

11. The system according to claim 10, comprising a plurality of transmitters located at predetermined locations remote from the processor, the transmitters being configured to transmit radio frequency to the lighting devices located within a zone about the transmitters, such that only the lighting devices within the zones emit light in response to the radio frequency.

12. The system according to claim 10, wherein the transmitter is directional and configured to direct the radio frequency to a specific location.

13. The system according to claim 11, wherein the processor is programmable to instruct specific transmitters to transmit the radio frequency.

14. The system according to claim 13, wherein the processor instructs the transmitters to transmit the radio frequency to create a pattern of lights about the transmitters.

15. The system according to claim 10, wherein the transmitter is located on a stage and configured to transmit the signal to lighting devices being used by an audience watching a concert being performed on the stage.

16. A method for controlling lighting devices using a wireless signal, the method comprising the steps of:
providing at least one transmitter configured to transmit the signal;
providing a processor communicably coupled to the transmitter, configured to provide instructions to the transmitter when to transmit the signal; and
providing a plurality of lighting devices, each lighting device comprising:
a receiver, configured to receive the signal;
a signal processor configured to process the signal; and
a light source electrically coupled to the processor and configured to emit a light after the signal has been processed.

17. The method of claim 16, wherein the signal is transmitted via radio frequency.

18. The method of claim 17, further comprising the step of positioning a plurality of transmitters at predetermined locations remote from the processor, and transmitting the radio frequency to the lighting devices located within a zone about the transmitters, such that only the lighting devices within the zones emit light in response to the radio frequency.

19. The method according to claim 17, wherein the light source comprises a plurality of light-emitting diodes, which may emit light individually, or jointly, to produce a desired color of light.

20. The method according to claim 19, further comprising the step of programming each lighting device with a unique address such that the processor is able to provide individual instructions to each lighting device.
